(19) United States
(12) Patent Application Publication
(10) Pub. No.: US 2017/0315424 A1
(43) Pub. Date: Nov. 2, 2017

(54) Carrier-Effect Based Switching Cell with Temperature Based Phase Compensation

(71) Applicant: Huawei Technologies Canada Co., Ltd., Ottawa (CA)

(72) Inventors: Dritan Celo, Nepean (CA); Dominic John Goodwill, Ottawa (CA); Lukas Chrostowski, Vancouver (CA); Sudip Shekhar, Vancouver (CA)

(21) Appl. No.: 15/143,889

(22) Filed: May 2, 2016

(51) Int. Cl. G02F 1/313

(52) U.S. Cl. CPC G02F 1/3136; G02F 1/3133; G02F 2203/21

(57) ABSTRACT

A temperature compensated carrier effect switching cell controls phase shifts to compensate for phase errors induced by temperature difference between arms of the switching cell. The temperature difference may be generated by driving the carrier effect region of the switching cell. Temperature sensors within the arms of the switching cell provide signals indicative of the temperature difference.

### TECHNICAL FIELD

The current application relates to carrier-effect based switching cells and in particular to phase compensation of carrier-effect based switching cells.

### BACKGROUND

Carrier-effect based switching cells can be used in photonic switches that are suitable for different applications. The individual switching cells of a photonic switch may use an interferometer structure, such as a Mach-Zehnder interferometer (MZI) structure that includes a PIN, or PN structure, in one or both arms of the interferometer structure. Carrier-based switching cells can provide a compact and low power switch that provides sufficiently fast switching speeds for use in metro networks and data center applications. Although carrier-effect based switching cells may provide fast switching times, they can suffer from reduced extinction ratios. Switch matrices may include numerous optical taps to provide feedback signals used in controlling the switching cells to provide the desired, or required routing of optical signals. Incorporation of optical taps may be expensive in terms of optical power and available space.

### SUMMARY

In accordance with the present disclosure there is provided a carrier-effect switching cell comprising: an interferometer structure comprising a first arm and a second arm optically coupled between an input coupler and an output coupler; a carrier-effect region in the first arm; a first temperature sensor within close proximity to the carrier-effect region in the first arm; a second temperature sensor in close proximity to the second arm; and a phase compensator within the first arm or the second arm and capable of inducing a phase shift in an optical signal based on an electrical compensation signal determined based on a temperature difference between the first temperature sensor and the second temperature sensor.

In a further embodiment of the carrier-effect switching cell, the first temperature sensor is located within the carrier-effect region of the first arm.

In a further embodiment of the carrier-effect switching cell, the carrier-effect region comprises a carrier-injection region.

In a further embodiment of the carrier-effect switching cell, the carrier-injection comprises a PIN junction.

In a further embodiment of the carrier-effect switching cell, the phase compensator comprises a thermo-optic phase shifter.

In a further embodiment, the carrier-effect switching cell further comprises a second carrier-effect region within the second arm, wherein the second temperature sensor is located within close proximity to the second carrier-effect region.

In a further embodiment of the carrier-effect switching cell, the first temperature sensor comprises a first temperature sensing diode and the second temperature sensor comprises a second temperature sensing diode.

In a further embodiment, the carrier-effect switching cell further temperature compensation functionality capable of providing the electrical compensation signal to the phase compensator.

In a further embodiment of the carrier-effect switching cell, the temperature compensation functionality is further capable of supplying a constant current to each of the first and second temperature sensing diodes.

In a further embodiment of the carrier-effect switching cell, the temperature compensation functionality is further capable of providing the electrical compensation signal with a temperature compensating power, P_{tc}, of: P_{tc}=kΔT; where: k is a settable gain factor; and ΔT is a temperature difference determined from the first temperature sensing diode and the second temperature sensing diode.

In a further embodiment of the carrier-effect switching cell, k is capable of being set during a calibration phase.

In a further embodiment, the carrier-effect switching cell further comprises temperature compensation functionality capable of providing the electrical compensation signal having a temperature compensating power, P_{tc}, of: P_{tc}=kΔT; where: k is a settable gain factor; and ΔT is a temperature difference determined from the first temperature sensor and the second temperature sensor.

In accordance with the present disclosure there is provided a photonic switch comprising: a plurality of optically coupled carrier-effect switching cells, each of the switching cells comprising: an interferometer structure comprising a first arm and a second arm optically coupled between an input coupler and an output coupler; a carrier-effect region in the first arm; a first temperature sensor within close proximity to the carrier-effect region in the first arm; a second temperature sensor in close proximity to the second arm; and a phase compensator within the first arm or the second arm and capable of inducing a phase shift in an optical signal based on an electrical compensation signal determined based on a temperature difference between the first temperature sensor and the second temperature sensor; routing functionality capable of providing routing signals to each of the plurality of switching cells for establishing optical paths through the plurality of switching cells; and temperature compensation functionality capable of providing electrical compensation signals to the phase compensators of each of the plurality of switching cells.

In accordance with the present disclosure there is provided a method of calibrating a plurality of temperature compensated switching cells of a switch, the method comprising: selecting one of the switching cells to calibrate; setting optical paths through the switch to optically couple an input of the selected switching cell to an input signal of the switch and an output of the selected switching cell to an optical tap of the switch; varying a gain factor k of the selected switching cell and monitoring an optical signal at the optical tap, the gain factor k applied to a temperature difference signal of the selected switching cell to generate a temperature compensation signal for the selected switching cell; setting the gain factor k for the selected switching cell to the varied gain factor k providing the highest signal at the optical tap; and calibrating a next switching cell.

In a further embodiment, the method further comprises varying an amplitude of current driving pulses of the selected switching cell while monitoring the output signal at the optical tap; setting an amplitude of the current driving pulses of the selected switching cell to a value providing the highest or the lowest optical signal.

In a further embodiment, the method further comprises enabling temperature compensation functionality of the selected switching cell.

### BRIEF DESCRIPTION OF THE DRAWINGS

Embodiments are described herein with references to the appended drawings, in which:

FIG. 1 depicts a photonic switch incorporating temperature compensation;

FIG. 2 depicts a temperature compensated carrier-effect based switching cell;

FIG. 3A depicts details of a temperature compensated switching cell;

FIG. 3B depicts a cross-section of the switching cell of FIG. 3A;

FIG. 3C depicts a further cross-section of the switching cell of FIG. 3A;

FIG. 4 depicts a temperature profile of the switching cell of FIG. 3A;

FIG. 5A-5B depict alternative phase compensators for use in a switching cell;

FIG. 6 depicts a method of calibrating temperature compensation functionality within a switch; and

FIG. 7 depicts a method of operating a switch matrix of temperature compensated switching cells.

### DETAILED DESCRIPTION

Carrier-effect based optical switches provide high speed switching of optical signals. Switching cells based on the carrier-effect, which may be either carrier injection or depletion, comprise a PIN, or PN, junction in at least one of a pair of arms of an interferometer structure, such as a Mach-Zehnder interferometer (MZI) structure. Driving at least one PIN or PN junction can induce a relative phase shift between optical signals carried by the two arms. The relative phase shift may be used to provide switching of an optical signal between outputs. For example, if no relative phase shift is provided, the optical signal may be output at a first output of the switching cell. If a relative phase shift of π degrees is provided, the optical signal may be output at a second output of the switching cell. In another example, no relative phase may result in the optical signal being evenly split between the two outputs, and a relative phase shift of either sign may switch the optical signal to be output at the first or the second output. Although a particular phase shift, such as π degrees, may result in complete switching of the optical signal to the second output, phase shift errors may result in a reduction of the intensity of the optical signal at the output. Accordingly, phase shift errors can reduce the extinction ratio, or contrast ratio, of the switching cell, and so an optical switch built from the switching cells. The phase errors may include contributions from constant phase shift errors that may be a result of the fabrication process as well as dynamic phase shift errors that arise from the operation of the switching cell. The constant phase shift errors may be compensated for by applying a constant bias phase shift. The dynamic phase shift errors may be more complex to account for due to their dynamic nature. One possible approach is to use optical taps to monitor the outputs of each individual switching cell to provide feedback information that can be used to compensate for the dynamic phase shift errors. The optical taps may also be used in compensating the constant phase shift errors. However, placing optical taps at each output of each individual switching cell may consume valuable real estate on a photonic chip and may also reduce the optical efficiency of the switching cells since each optical tap consumes optical power. As described further herein, the dynamic phase shift error, or at least one source of the dynamic phase shift error, may be compensated for based on a temperature difference between the two arms of a switching cell.

A temperature sensing diode may be incorporated into the waveguide of each arm and used to provide a voltage signal indicative of the temperature difference between the two arms. The voltage difference signal may be used to control a phase shift compensator that induces a compensating dynamic phase shift to counteract the phase shift error induced by the temperature difference between the two arms. As described further herein, switches built using temperature-compensated switching cells may provide improved contrast ratios, as compared to un-compensated switching cells, without requiring optical taps be placed at all outputs of the individual switching cells.

Under ideal operation, a carrier-effect based optical switch generates a relative phase shift from current flowing at a carrier injection or depletion region. However, in practical devices, driving the carrier injection or depletion region generates a temperature difference between the two arms, resulting in an undesirable phase shift error. Reducing a distance between the two arms may help reduce the temperature difference between the two arms; however, it does not eliminate the temperature difference. Using current fabrication processes, a minimum gap between arms is approximately 12 μm, which can result in a temperature difference when driving the PN junction of approximately 0.9° C. Such a temperature difference between arms may provide significant optical crosstalk unless it is compensated for.

A carrier-effect based switching cell may be fabricated with a diode associated with each arm of the switching cell. The diodes may be used as temperature sensing diodes in order to provide feedback information used to compensate for the phase shift errors resulting from temperature difference across the two arms.

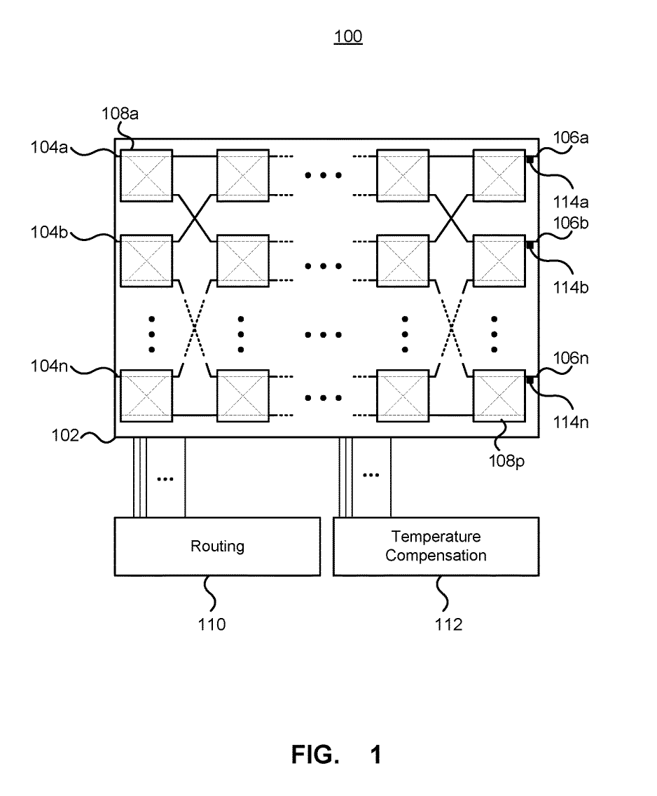

FIG. 1 depicts a photonic switch incorporating temperature compensation. The switch 100 comprises a switch matrix 102, or switch fabric, that allows optical paths to be established between inputs 104a-104n (referred to collectively as inputs 104) of the switch 100 and outputs 106a-106n (referred to collectively as outputs 106) of the switch 100. The switch matrix 102 comprises a plurality of individual switching cells 108a-108p (referred to collectively as switching cells 108). The individual switching cells 108 and optical connections between them can be arranged in various different ways depending upon the particular switch architecture. The individual switching cells 108 are capable of switching an optical signal that is present on one of the inputs of the switching cell to one of the outputs of the switching cell. By controlling the switching characteristics of the individual switching cells 108, optical paths can be established between the switch's inputs 104 and outputs 106. Routing functionality 110 controls the switching characteristics of the switching cells 108 in order to provide requested optical paths. The routing functionality 110 may be provided on an electronic chip or board that is electrically connected to the photonic chip or board providing the switch matrix 102. Alternatively, the routing functionality may be provided by electronics present on the same chip or board as the switch matrix 102.

The individual switching cells 108 are provided by carrier-effect based switching cells. Each of the switching cell comprises a pair of arms within an interferometer structure with a carrier injection, or depletion region located within at least one of the arms. Driving the carrier-effect region induces a relative phase shift between optical signals in the pair of arms, which causes the optical signal to be output to one of two outputs of the individual switching cell. The routing functionality 110 may determine the appropriate driving signals in order to establish the desired optical paths through the individual switching cells 108. However, driving the switching cells to induce a phase shift will also generate a temperature difference between the two arms, which causes a temperature dependent phase shift between optical signals in the two arms of switching cells. As described further below, temperature sensors in each arm of the individual switching cells can detect the temperature difference and temperature compensation functionality 112 can use the determined temperature differences of the individual switching cells 108 to control phase compensators within each of the switching cells in order to compensate for a phase error induced by the temperature difference.

The switch 100, and more particularly the switch matrix 102, is depicted as having a small number of optical taps, which are represented schematically as small black boxes, 114a-114n (referred to collectively as optical taps 114). With each individual switching cell 108 being temperature-compensated, optical taps are not required at each output of each individual switching cell 108. As described further below, the optical taps 114 may be used during a calibration phase in order to calibrate the temperature dependent phase compensation for each of the switching cells 108. Although depicted as being present on the switch outputs 106, that is the outputs of the final stage of switching cells, depending upon the architecture of the switch matrix 102, as well as the calibration technique used, additional optical taps may be used on some of the outputs of the switching cells 108.

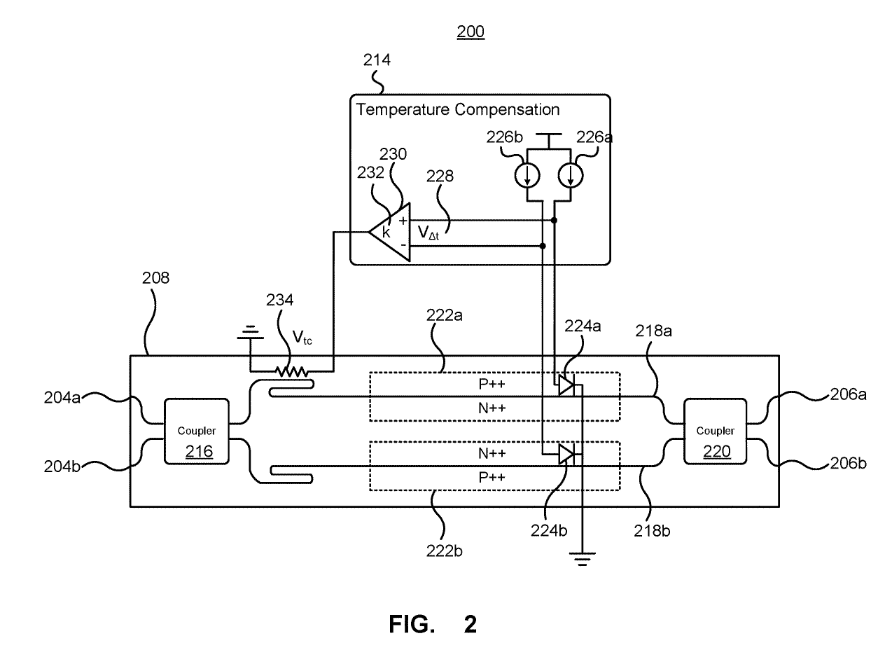

FIG. 2 depicts a temperature compensated carrier-effect based switching cell. The temperature compensated switching cell 200 comprises an optical switching cell portion 208 and an electrical temperature compensation portion 214. When the temperature compensated switching cell 200 is incorporated into a switch, such as switch 100, the electrical compensation portion 214 may be provided as a portion of the temperature compensation functionality 112 of the switch 100. The optical switching cell is described further below as a carrier-injection optical switching cell, however, carrier depletion could also be employed. The optical switching cell 208 is depicted as an MZI structure comprising a pair of switching cell inputs 204a, 204b (referred to collectively as switching cell inputs 204) optically coupled to a coupler 216. The coupler 216 splits an optical signal present at either of the switching cell inputs 204 evenly between two arms 218a, 218b (referred to collectively as arms 218). A second coupler 220 combines the optical signals present in the arms 218. Depending upon the relative phase shift between the optical signals of the two arms 218, and the particular design of the coupler 220, the optical signals will be combined and output to one of two switching cell outputs 206a, 206b (referred to collectively as switching cell outputs 206). A single carrier injection region may be located in one of the arms 218, or as depicted in FIG. 2 carrier injection regions 222a, 222b (referred to collectively as carrier injection regions 222) may be located in each of the arms 218. As depicted the carrier injection regions 222 comprise a PN junction. The PN junction may comprise a PIN junction with lightly doped or intrinsic silicon between heavily doped regions. Alternatively, the carrier injection regions 222 may comprise a field effect region. The field effect region may comprise a region of silicon separated by means of a thin insulator from an electrode that applies an electric field to the silicon, which may be in a polysilicon gate oxide insulator silicon capacitor arrangement. The carrier injection regions 222 are driven by electrical signals (not depicted) that are provided by routing functionality, such as routing functionality 110 described above with reference to FIG. 1.

Temperature sensors, such as temperature sensing diodes 224a, 224b (referred to collectively as temperature sensors 224), or other devices, are integrated into the arms 218 of the optical switching cell 208. The temperature sensors 224 may be located in close proximity to the optical waveguides in order to detect the temperature in each arm. Further, the temperature sensors 224 may be monolithically integrated into the carrier injection region or regions 222 of the arms 218. The integrated temperature sensors 224 do not consume optical power, and as such the temperature sensors 224 may be used to provide dynamic real-time compensation to phase errors without incurring additional losses of optical power. The temperature sensors 224 are located as close to the waveguide as possible, or practical.

A temperature sensing diode may comprise a diode such as a PN junction or Schottky junction diode or diode-connected MOSFET. As conventionally understood, when a forward-bias voltage is applied to such a diode, a forward current passes through the diode according to the well-known diode equation. Conversely, if a forward current is passed through the diode, then a voltage is induced across the diode according to the inverse of the diode equation. The diode equation has a strong temperature dependency, and therefore the induced voltage at a given current depends strongly on the temperature of the diode.

The temperature sensors 224 are connected to temperature compensation functionality 214. If the temperature sensors 224 are provided by two identical, or nearly identical, temperature sensing diodes and are forward biased with a constant current, depicted as being provided by temperature independent current sources 226a, 226b, then a voltage difference 228, depicted as ΔVₜ, will be proportional to a temperature difference between the two diodes. With the temperature sensors 224 located in close proximity to the arms 218, the temperature difference between the temperature sensors 224 will correspond to the temperature difference between the arms 218. A compensating circuit 230 receives the voltage difference 228 ΔVₜ and determines an amount of power to supply to a phase compensator 234 in order to compensate for the temperature-dependent phase error. The power, P_{tc}, may be determined by the compensating circuit 230 according to:

Pₜᵥ=kΔVₜ (1)

The phase compensator 234 is depicted as being provided by a thermo-optic phase shifter. The thermo-optic phase shifter may be provided by a heating element located adjacent to at least one of the arms 218. The heating element may be provided by a heating resistor made from, for example, titanium nitride, a doped silicon region, or other possible alternatives. The power output by the heating element as a function of heater driving voltage may be temperature dependent, however the dependence would be small and would not need to be accounted for. The thermo optic phase shifter of the phase compensator 234 induces a phase shift that is proportional to the power P_{tc}. As indicated above, the power P_{tc} is proportional to the voltage difference ΔVₜ 228 between the two temperature sensors 224, which in turn is proportional to the temperature difference between the two arms 218 of the optical switching cell 208. The compensating circuit 230 may determine the current I_{tc} or voltage V_{tc} to supply to the heating element in order to induce a phase shift to compensate for temperature induced phase shift errors according to the following equations, which are mutually consistent:

$${P}_{tc} = {I}_{tc}^{2} {R}_{heater}$$

$$or$$

$${P}_{tc} = \frac{{V}_{tc}^{2}}{{R}_{heater}}$$

$$or$$

$${P}_{tc} = {I}_{tc} {V}_{tc}$$

As described above, a temperature compensated switching cell, such as the optical switching cell 200, can provide thermal compensation to compensate for self-heating effects of integrated carrier injection, or depletion, optical switching cells. The thermal compensation may use diode based temperature measurements, made using integrated temperature sensing diodes located in each MZI arm as close as possible to the waveguide of the arm. Temperature compensation functionality can convert temperature differences at the temperature sensing diodes to a voltage difference that may be provided to an operational amplifier, or op amp 230. The output of the op amp 230 feeds an integrated heater within at least one of the MZI arms that compensates for the self-induced temperature difference and hence, counteracts the thermo-optic phase shift within the carrier injection section. The output of the op amp 230 corresponds to the voltage difference 228 from the temperature sensors 224. The op amp 230 may apply a gain factor k 232 to the voltage difference 228 from the temperature sensors 224 to generate the output. The feedback works by directly measuring the temperature difference between MZI arms and applying heater electrical power proportional to the measured temperature difference.

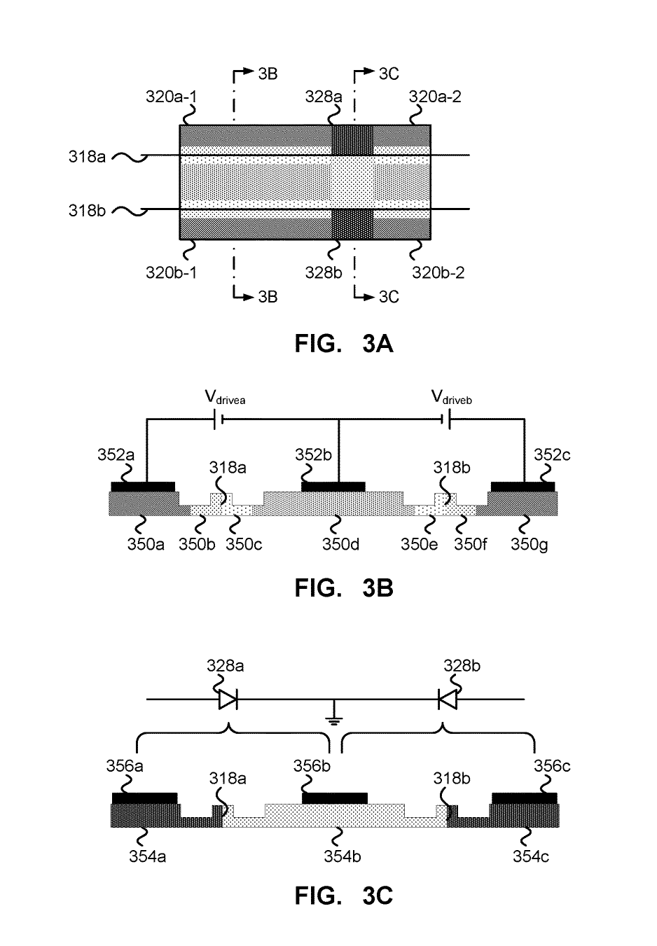

FIG. 3A depicts details of a temperature compensated switching cell. FIG. 3B depicts a cross-section of the switching cell of FIG. 3A along cut line 3B. FIG. 3C depicts a further cross-section of the switching cell of FIG. 3A along cut line 3C.

FIG. 3A depicts doping regions associated with waveguides 318a, 318b (referred to collectively as waveguides 318). The waveguides 318 and doping regions of FIG. 3A may be used within an optical switching cell such as the optical switching cell 208 described above with reference to FIG. 2. The doping regions associated with the first, or top, waveguide 318a comprise two carrier injection regions 320a-1, 320a-2 that provide an electro-optical phase shifter. The two carrier injection regions 320a-1, 320a-2 are separated by a diode doping region 328a that provides a temperature sensing diode within the waveguide 318a. The diode doping region 328a may be disposed at different locations along the waveguide 318a, however locating the diode doping region 328a between the two carrier injection regions 320a-1, 320a-2 allows the temperature sensing diode 328a to be disposed within the electro-optical phase shifter where the temperature difference between the waveguides 318 of two arms may be the greatest. The doping regions associated with the second waveguide 318b are similar to those described above with the waveguide 318a. The doping regions comprise two carrier injection regions 320b-1, 320b-2 separated by a second diode doping region 328b that provides second temperature sensing diode 318a. The diode doping regions 328a, 328b may be relatively short, such as a few micrometres long, compared to the other doping regions which may be 10s to 100s of micrometers long.

FIG. 3B depicts a cross-section of the switching cell of FIG. 3A along cut line 3B. The cross-section of the second carrier injection regions 320a-2, 320b-2 may be substantially the same as the cross section depicted in FIG. 3B. The cross-section depicted in FIG. 3B depicts doping of a silicon layer. As depicted the silicon provides two waveguides 318a, 318b. The silicon is doped with different impurities to provide different doping regions. The regions of the first waveguide 318a may include a highly positively (P++) doped region 350a, that transitions to a lightly positively doped or intrinsic region 350b that is next to a lightly negatively doped or intrinsic region 350c. The lightly negatively doped or intrinsic region 350c transitions to a highly negatively (N++) doped region 350d. The doping regions 350a, 350b, 350c, 350d provide a PN or PIN junction that can change the refractive index of the waveguide 318a. As depicted, metal contacts 352a, 352b contact the doping regions 350a, 350d that allow the PN or PIN junction to be driven with a drive voltage V_{drivea}. The waveguide 318b is associated with similar doping regions as described above for waveguide 318a, namely the highly negatively doped region 350d transitions to a lightly negatively doped or intrinsic region 350e that is next to a lightly positively doped or intrinsic region 350f. The lightly positively doped or intrinsic region 350f transitions to a highly positively doped region 350g. The doping regions 350d, 350e, 350f, 350g provide a PN or PIN junction that can change the refractive index of the waveguide 318b. As depicted, metal contacts 352b, 352c contact the doping regions 350d, 350g that allow the PN or PIN junction to be driven with a drive voltage V_{driveb}. FIG. 3B depicts the doping regions and the corresponding external circuit, namely the two drive voltages V_{drivea} and V_{driveb}.

Although depicted as having carrier injection regions associated with each of the waveguides 318, a carrier injection region may be associated with only one of the waveguides 318. Alternatively, carrier injections regions may be associated with each of the waveguides 318 and only one of the carrier regions may be driven instead of both. That is, the temperature compensated switching cell may be a single-drive or dual drive switching cell.

FIG. 3C depicts a further cross-section of the switching cell of FIG. 3A. As depicted, the same silicon cross section is fabricated with different doping regions. As depicted a highly positively doped region 354a is adjacent a highly negatively doped region 354b. The two regions 354a, 354b provide a first temperature sensing diode, shown schematically as temperature sensing diode 328a, that can be supplied with a constant current through associated metal contacts 356a, 356b that are arranged on doping regions 354a, 354b. A second temperature sensing diode associated with the second waveguide 318b may be provided by the highly negatively doped region 354b and the highly positively doped region 354c. The second temperature sensing diode provided by the doping regions 354b, 354c is shown schematically as temperature sensing diode 328b.

Doping regions of optical switching cells have been described above. The concentrations, and dimensions of the doping regions described above are intended to be illustrative of varying the doping regions to provide a monolithically integrated temperature sensing diode. The specific concentrations and dimensions of the doping regions may vary depending upon the fabrication process. Each temperature sensor may be a simple diode with linear relation V_{d}=f(T) for a constant diode current I_{d}, where:

$${V}_{d} = \frac{nKT}{q} ln ( \frac{{I}_{d}}{{I}_{s}} )$$

In the above equation:

K is the Boltzmann constant;

T is an absolute temperature of the diode;

q is the electron charge;

Iₛ is the reverse bias saturation current; and

n is a fabrication constant that is usually between 1 and 2.

From the above, two forward-biased diodes with identical size will have a voltage V_{D} difference proportional to the temperature difference between the diodes according to:

$${V}_{D} = {V}_{d 1} - {V}_{d 2} = \frac{nK}{q} ln ( \frac{{I}_{d}}{{I}_{s}} ) ( {T}_{1} - {T}_{2} )$$

As described above, V_{D} may be provided to circuitry that converts the directly measured V_{D} into an output voltage or current, that is power, that is proportional to V_{D}. The output power feeds a resistive heater element of a thermo-optic phase shifter providing the dynamic temperature-dependent phase error compensation. The electrical power relation between the carrier injection section and the thermo-optic section may be described by

P_{tc}=kΔT

Where k is defined by the carrier injection phase shifter cross-section and the thermo-optic phase shifter cross section. It is possible to calculate k, however it can be accurately obtained and validated through a calibration procedure.

The diodes may be integrated in a standard CMOS photonic fabrication process using a foundry platform with P-doped and N-doped regions. The temperature compensation functionality that provides the phase compensating power based on the temperature difference determined from temperature sensing diodes may be implemented on CMOS technology. The electrical chip and photonic chip may be monolithically integrated, or electrically connected using flip-chip bonding or bonding wires. The temperature compensation functionality may be provided by a programmable gain amplifier or an ADC-based digital feedback.

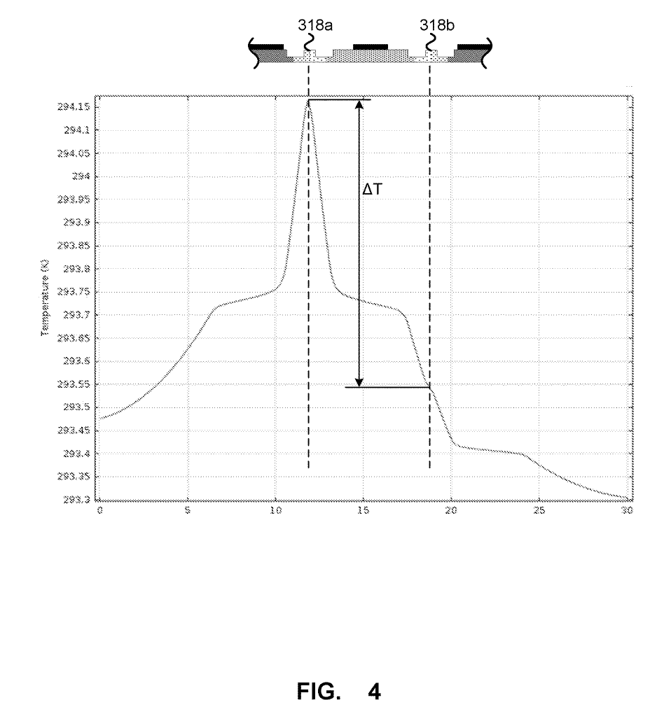

FIG. 4 depicts a temperature profile of the switching cell of FIG. 3A. The temperature profile depicted in FIG. 4 assumes that only one carrier injection region of the switching cell is driven, namely that associated with the first waveguide 318a. When different voltages are applied to the carrier effect regions there will be a temperature difference across the switching cell. As depicted, the highest temperature is located within the waveguide that is being driven. With temperature sensing diodes located within, or within close proximity to, each of the waveguides 318 it is possible to measure the temperature difference ΔT, and then compensate for the phase error induced by the temperature difference.

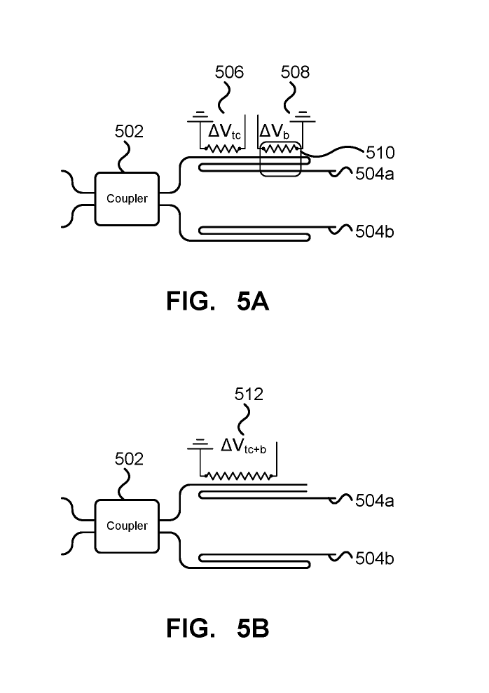

FIGS. 5A and 5B depict alternative phase compensators for use in a switching cell. The above has described a phase compensator located within one of the arms of an MZI structure. The phase compensator described above may be provided by a heater element that is supplied with power that is proportional to the temperature difference. As described above, the phase compensator may be a thermo-optic phase compensator comprising a heater element underlying a section of the waveguide. The overlapping waveguide section may be folded to increase the thermo-optic efficiency. The thermo optic section of the MZI arms may be distant from each other in order to avoid or at least reduce temperature crosstalk.

FIG. 5A depicts a phase compensator 506 for compensating for temperature based phase shift errors. A second bias phase shifter 508, which may also be a thermo-optic phase shifter may be provided separately from the temperature dependent phase compensator 506. The bias phase shifter 508 provides phase shift error compensation for constant errors and as such may be relatively slow reacting. As such a thermal undercut, depicted schematically as oval 510, may be provided that acts as a thermal insulator, which may reduce the power consumption at the expense of reaction time. Since the temperature dependent phase compensator 506 compensates for temperature dependent phase shift errors that arise from driving the junction, the phase compensator 506 should react relatively quickly, and as such no thermal undercut is provided. The temperature based phase compensator 506 and the bias phase shifter 508 are depicted as being provided in the same arm of the MZI structure, depicted as waveguide 504a; however, the temperature based phase compensator 506 and the bias phase shifter 508 could be associated with the other waveguide 504b. Further, the temperature based phase compensator 506 and the bias phase shifter 508 are depicted as being located adjacent to an input coupler 502; however, the temperature based phase compensator 506 and the bias phase shifter 508 could be located at any convenient location in the switching cell.

FIG. 5B depicts a further alternative temperature based phase compensator. The temperature based phase compensator 512 is depicted as a single heater element, without a thermal undercut, may be used to provide phase compensation for the constant phase shift errors, as well as the temperature dependent phase shift errors.

The temperature compensated optical switching cell described above can provide real-time phase compensation for temperature dependent phase errors. The temperature difference that needs to be compensated for may be determined using monolithically integrated temperature sensing diodes. Although the performance of the temperature sensing diodes may change as the diodes age, it may not be necessary to calibrate for aging effect. The diodes are lateral bipolar silicon diodes, and may be manufactured in a high quality silicon bipolar production line, which will reduce an amount of aging. Further, any aging that may occur will likely be equal in the two diodes since the diodes are very close to each other on the same die. It is necessary to calibrate k where P=kΔT. P is the electrical power that drives the thermo-optic heater to compensate for optical phase shifts due to ΔT, where ΔT is the measured temperature difference between the carrier injection arms. The process for calibrating an individual temperature compensated switching cell is to disable the temperature-based phase compensation and drive the switching cell with short current pulses through the carrier injection drive current. The length of each pulse may be for example approximately 100 ns and is selected to be long compared to the carrier injection characteristic time, which is in the order of a few ns, and short compared to the thermal compensator's time, which is in the order of a few μs. The amplitude of the short current pulse train is varied in order to maximize an output signal. Using the drive current that provided the maximum output signal, the temperature based phase compensation is enabled and the value of k varied to maximize the output.

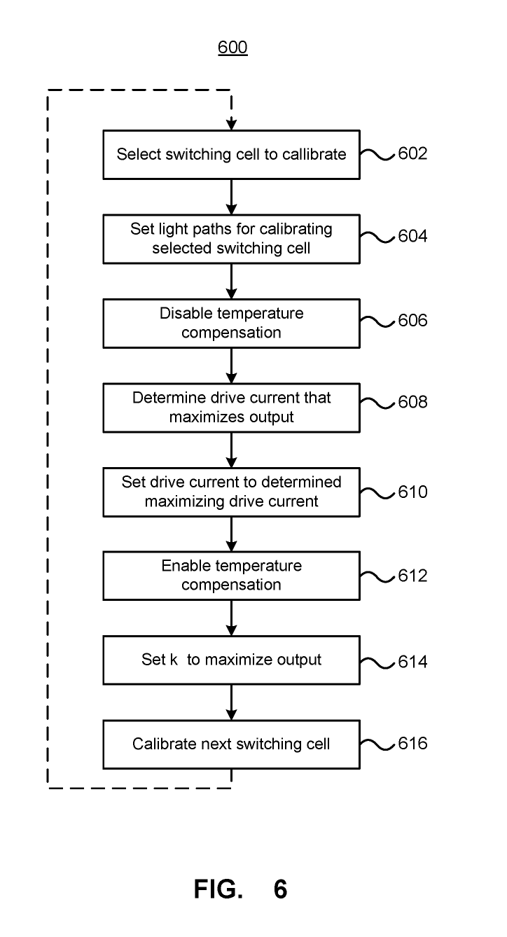

FIG. 6 depicts a method of calibrating temperature compensation functionality within a switch. The above described the calibration process for a single temperature compensated switching cell. The method of FIG. 6 assumes that the bias compensation for compensating the constant phase shift errors has already been established for the switching cells, which may be done using known calibration techniques. The calibration process for a switch composed of individual temperature compensated switching cells is similar; however, in order to reduce the number of optical taps required, light paths are established to an optical tap and used to calibrate a switching cell. Accordingly, the switch may not have optical taps located at outputs of each switching cell, but rather at only a few locations, such as at the outputs of switching cells in the n^{th} column of the switch matrix.

The method 600 may be performed by functionality implemented in a controller, such as the temperature compensation functionality. The method 600 begins with selecting a switching cell in a switch matrix, such as switch matrix 102, to calibrate (602). Once the switching cell to calibrate is selected, light paths are established (604) through other switching cells, from an input of the switch matrix to the selected switching cell, and from an output of the selected switching cell when the switching cell is in a state associated with the largest temperature difference, for example the cross state to an optical tap in the switch matrix, such as one of the optical taps 114. The temperature compensation is disabled (606), and the drive current is varied with short pulses in order to determine the drive current that maximizes the output of the optical signal detected by the optical tap (608). Once the drive current is determined that maximizes the optical output, the drive current is set to the determined maximizing drive current (610) and the temperature compensation for the selected switching cell may be enabled (612). With the temperature compensation enabled and the switching cell driven by the static drive current determined to maximize the optical output, the value of a gain factor k, which is applied to the difference signal from the temperature sensors. is adjusted in order to maximize the output of the optical signal detected by the optical tap and the maximum value of k is set in the selected switching cell (614). With the individual switching cell calibrated, calibration proceeds to a next switching cell (616).

The method 600 assumes that the drive current of the switching cells has not been set and as such calibrates the initial drive current with the temperature compensation disabled (606-612). However, it is possible to calibrate the temperature compensation of the individual switching cells without having to calibrate the drive current at the same time. For example, the drive current of the switching cells may be calibrated and the temperature compensation can be calibrated separately.

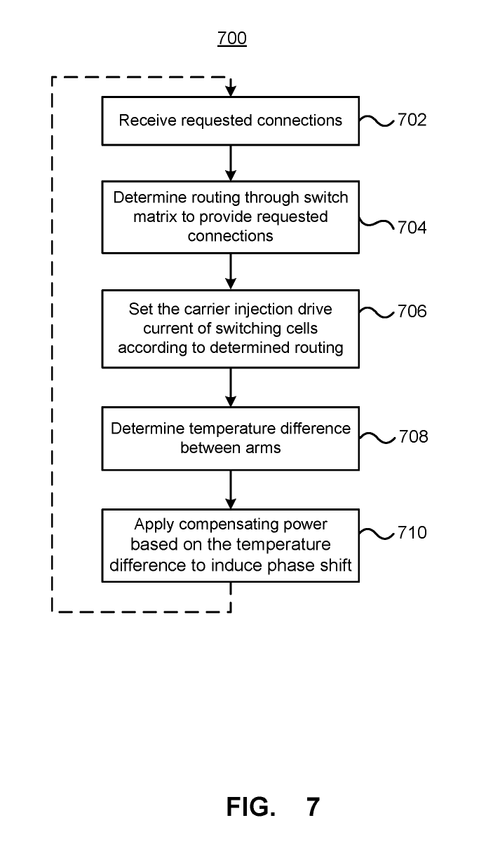

FIG. 7 depicts a method of operating a switch matrix of temperature compensated switching cells. The method 700 may be performed by functionality implemented in a controller, such as the routing and temperature compensation functionality. The method may be used in operating a switching matrix of a plurality of temperature compensating carrier-effect switching cells, such as the switch matrix 100 described above with particular reference to FIG. 1. The method 700 receives one or more connection requests (702) to be established through a switch matrix and determines the routing through the switch matrix to provide the requested connections (704). Depending upon the architecture of the switch matrix, and the routing functionality, the determination of the routing through the switch matrix may be done in a asynchronous mode or a synchronous mode. In a synchronous mode, all of the requested connections are established before a transmission time, while in the asynchronous mode, requested connections can be established through the switch matrix at any time. Once the routing is determined, the carrier injection, or depletion drive currents are set according to the determined routing (706). The drive currents configure the switching cells into the proper state, such as a cross or bar state, in order to provide the requested connections according to the determined routing. With the drive currents set, the individual switching cells may develop temperature differences between the arms of the switching cells. With the driving currents applied, the temperature difference between the arms (708) of the switching cells is determined, for example using the temperature sensing diodes of the switching cells. As the temperature difference between the arms is determined, the temperature difference is used to apply compensating power to the switching cells based on the temperature difference in order to induce phase shift to compensate for phase shift errors caused by temperature differences between arms resulting from driving the carrier injection, or depletion regions of the individual switches. The temperature based compensation continues based upon the detected temperature difference. The method 700 may provide real-time, or near real-time temperature based phase shift compensation, which may provide a carrier effect based optical switch with an increased contrast ratio.

The present disclosure provided, for the purposes of explanation, numerous specific embodiments, implementations, examples and details in order to provide a thorough understanding of the invention. It is apparent, however, that the embodiments may be practiced without all of the specific details or with an equivalent arrangement. In other instances, some well-known structures and devices are shown in block diagram form, or omitted, in order to avoid unnecessarily obscuring the embodiments of the invention. The description should in no way be limited to the illustrative implementations, drawings, and techniques illustrated, including the exemplary designs and implementations illustrated and described herein, but may be modified within the scope of the appended claims along with their full scope of equivalents.

While several embodiments have been provided in the present disclosure, it should be understood that the disclosed systems and components might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

What is claimed is:

1. A carrier-effect switching cell comprising:
an interferometer structure comprising a first arm and a second arm optically coupled between an input coupler and an output coupler;
a carrier-effect region in the first arm;
a first temperature sensor within close proximity to the carrier-effect region in the first arm;
a second temperature sensor in close proximity to the second arm; and
a phase compensator within the first arm or the second arm and capable of inducing a phase shift in an optical signal based on an electrical compensation signal determined based on a temperature difference between the first temperature sensor and the second temperature sensor.

2. The carrier-effect switching cell of claim 1, wherein the first temperature sensor is located within the carrier-effect region of the first arm.

3. The carrier-effect switching cell of claim 1, wherein the carrier-effect region comprises a carrier-injection region.

4. The carrier-effect switching cell of claim 3, wherein the carrier-injection comprises a PIN junction.

5. The carrier-effect switching cell of claim 1, wherein the phase compensator comprises a thermo-optic phase shifter.

6. The carrier-effect switching cell of claim 1, further comprising a second carrier-effect region within the second arm, wherein the second temperature sensor is located within close proximity to the second carrier-effect region.

7. The carrier-effect switching cell of claim 1, wherein the first temperature sensor comprises a first temperature sensing diode and the second temperature sensor comprises a second temperature sensing diode.

8. The carrier-effect switching cell of claim 7, further comprising temperature compensation functionality capable of providing the electrical compensation signal to the phase compensator.

9. The carrier-effect switching cell of claim 8, wherein the temperature compensation functionality is further capable of supplying a constant current to each of the first and second temperature sensing diodes.

10. The carrier-effect switching cell of claim 9, wherein the temperature compensation functionality is further capable of providing the electrical compensation signal with a temperature compensating power, P_{tc}, of:
P_{tc}=kΔT;
where:
k is a settable gain factor; and
ΔT is a temperature difference determined from the first temperature sensing diode and the second temperature sensing diode.

11. The carrier-effect switching cell of claim 10, wherein k is capable of being set during a calibration phase.

12. The carrier-effect switching cell of claim 1, further comprising temperature compensation functionality capable of providing the electrical compensation signal having a temperature compensating power, P_{tc}, of:
P_{tc}=kΔT;
where:
k is a settable gain factor; and
ΔT is a temperature difference determined from the first temperature sensor and the second temperature sensor.

13. A photonic switch comprising:
a plurality of optically coupled carrier-effect switching cells, each of the switching cells comprising:
an interferometer structure comprising a first arm and a second arm optically coupled between an input coupler and an output coupler;
a carrier-effect region in the first arm;
a first temperature sensor within close proximity to the carrier-effect region in the first arm;
a second temperature sensor in close proximity to the second arm; and
a phase compensator within the first arm or the second arm and capable of inducing a phase shift in an optical signal based on an electrical compensation signal determined based on a temperature difference between the first temperature sensor and the second temperature sensor;
routing functionality capable of providing routing signals to each of the plurality of switching cells for establishing optical paths through the plurality of switching cells; and
temperature compensation functionality capable of providing electrical compensation signals to the phase compensators of each of the plurality of switching cells.

14. A method of calibrating a plurality of temperature compensated switching cells of a switch, the method comprising:
selecting one of the switching cells to calibrate;
setting optical paths through the switch to optically couple an input of the selected switching cell to an input signal of the switch and an output of the selected switching cell to an optical tap of the switch;
varying a gain factor k of the selected switching cell and monitoring an optical signal at the optical tap, the gain factor k applied to a temperature difference signal of the selected switching cell to generate a temperature compensation signal for the selected switching cell;
setting the gain factor k for the selected switching cell to the varied gain factor k providing the highest signal at the optical tap; and
calibrating a next switching cell.

15. The method of claim 14, further comprising:
varying an amplitude of current driving pulses of the selected switching cell while monitoring the output signal at the optical tap;
setting an amplitude of the current driving pulses of the selected switching cell to a value providing the highest or the lowest optical signal.

16. The method of claim 15, further comprising enabling temperature compensation functionality of the selected switching cell.
